(19) United States
(12) Patent Application Publication
(10) Pub. No.: US 2025/0272613 A1
(43) Pub. Date: Aug. 28, 2025

(54) COMPUTATIONALLY EFFICIENT MACHINE LEARNING

(71) Applicant: E-GROUP ICT SOFTWARE INFORMATIKAI ZRT., Budapest (HU)

(72) Inventors: Roland HOLLÓS, Pécs (HU); Yuping YAN, Budapest (HU); Ákos TÉNYI, Budapest (HU)

(73) Assignee: E-GROUP ICT SOFTWARE INFORMATIKAI ZRT., Budapest (HU)

(21) Appl. No.: 18/858,104

(22) PCT Filed: Apr. 21, 2023
(86) PCT No.: PCT/EP2023/060521

§ 371 Date: Oct. 18, 2024

(30) Foreign Application Priority Data
Apr. 21, 2022 (EP) 22462006.2

(51) Int. Cl. G06N 20/00

(52) U.S. Cl. CPC G06N 20/00

(57) ABSTRACT

The computer-implemented method for computationally efficient machine learning comprises a) generating, by the server computing device, a set of initial model parameters; b) generating, by the server computing device, a set of partitioning parameters including at least the parameters Number of partitions and Minimum number of data points in the partitions; c) communicating, by the server computing device, the set of initial model parameters and the partitioning parameters to each client computing device; d) obtaining, by each client computing device, global values corresponding to the set of initial parameters from the server computing device; e) selecting, by the server computing device, a client computing device based on a global sequence of all client computing devices; f) communicating, by the server computing device, machine learning-based model parameters to the selected client computing device; g) obtaining, by the selected client computing device, global values corresponding to the machine learning-based model parameters; h) incrementally training, by the selected client computing device, the machine-learned model based, at least in part, on a partition of the local dataset to obtain updated machine learning-based model parameters, said partition being selected from the local dataset according to a predefined scheme; i) communicating, by the selected client computing device, the updated machine learning-based model parameters to the server computing device; j) repeating steps d)-i) until all predefined conditions are satisfied.

### FIELD

The present disclosure relates generally to machine learning. More particularly, the present disclosure relates to computationally efficient federated machine learning.

### BACKGROUND

Federated learning relies on transmission of model parameters from client computing devices to a server computing device, and from the server computing device to the client computing devices. Federated learning (also called collaborative learning) is a machine learning technique for the collaborative training of machine learning models by multiple participants without the sharing of raw data. However, current researches demonstrate that traditional federated learning schemes based on gradient model update are not efficient in communication cost and show low accuracy performance on the non-IID (not identically distributed and independent) data structure. Communication cost and non-IID are two barriers in traditional federated learning schemes. How to build computational efficient machine learning using non-IID data is a key challenge.

The concept of the local learning is shown in FIG. 1. In this learning scheme, there are a plurality of local machine learning models 10 that are separately trained by local computing devices 12 using a sample from a local dataset. The local datasets are typically separated in different geographical areas. This learning scheme, however, does not generalize, the local models 10 reflect features and biases of local data, and when used at other geographical areas, they most often provide biased or inaccurate predictions. The performance, the model accuracy and the complexity of this learning scheme heavily rely on the properties of individual local computing devices 12.

The concept of the central learning is shown in FIG. 2. In contrast to the local learning, the central learning performs centralization of data and parameters originating from different sources to solve the problem of insufficient amount of local data for local learning. In this learning scheme, there is single (global) machine learning model 20 that is subsequently trained by using aggregated samples from the local datasets. The samples are sent by the local computing devices 22 through communication channels to a server (not shown) responsible for training a global model 20. Access to the global model 20 by the local computing devices 22 is managed by the server also acting as an arbitrating device. The arbitrating device itself, however, does not make any change in the global model 20. Typical applications of the central learning are, for example, extensions of application forms deployed globally, like Google's advertisement recommendation system or Netflix's video recommendation system. However, along with the increase in the data traffic required for moving data in the centralized scheme, this kind of learning may raise concerns about data ownership, confidentiality, privacy and security among data owners, as well as the possibility of creating data monopolies in favour of data aggregators.

For improving security and solving data confidentiality problems in the centralized learning scheme, federated learning schemes have been proposed. The concept of federated learning is shown in FIG. 3. In a federated learning scheme, there is a plurality of local machine learning models 30 that are independently trained by several local computing devices 32 using samples from the local datasets. The local models 30 are periodically forwarded to a central server computing device 34 that maintains a global machine learning model 36. The server computing device 34 manages access to the global model 30 by the local computing devices 32 and securely aggregates the local models 30 into the global model 36 once any one or more of the local models 30 has been updated.

In the centralized federated learning protocols, the server orchestrates communication but learning is not incremental between peer models, while the private algorithms based on incremental learning are decentralized (Sheller et al. “Multi-institutional deep learning modeling without sharing patient data: A feasibility study on brain tumor segmentation.” International MICCAI Brainlesion Workshop, pp. 92-104. Springer, Cham, 2018). Although a decentralized system provides some advantages over a centralized framework, they are usually harder to implement and more prone to implementation errors. Furthermore, in the Cyclic Institutional Incremental Learning (CIIL) scheme (Chang et al., “Distributed deep learning networks among institutions for medical imaging”, Journal of the American Medical Informatics Association, Volume 25, Issue 8, August 2018, pp. 945-954) there is no mechanism described to provide robustness (e.g., error connected to a client).

In the CIIL scheme, the order of the client computing devices in the update queue is fixed. If the datasets of the client computing devices are not identically distributed and independent (non-IID), catastrophic forgetting (after updating the model on new dataset, the updated model will be less accurate on the previously learned data, i.e. “it forgets what it learned previously”) can be even higher because the datasets of the client computing devices in the all-data distribution can have subsets where two datasets are not too distant from each other.

Continuous model updating is an inherent characteristic of incremental learning, thus catastrophic learning is a major challenge in this field. Recently many solutions have been provided to address the problem. One of them is the so called EWC (Kirkpatrick et al, “Overcoming catastrophic forgetting in neural networks”, Proceedings of the National Academy of Sciences 114, No. 13 (2017): 3521-3526.), which penalizes the loss function based on the distribution of the individual weights in the previous model. The method according to the present invention is designed to use this tool from the beginning.

An innovative chained secure multi-party computing technique, named Chained-PPEL based on the federated learning is proposed and applied to edge computing (Li et al, “Privacy-Preserving Federated Learning Framework Based on Chained Secure Multi-party Computing”). In this framework, the server sends global model parameters to all the clients, then the clients train the global model in a chain and the last client sends back the global model to the server. This chained-PPEL focuses on the privacy-preserving federated learning of preventing sensitive information leakage.

It is therefore an object of the present invention to eliminate, at least partly, the drawbacks of the currently used collaborative learning schemes and to provide a method for improved federated machine learning that provides computational efficiency leading to significant computation cost reductions, improves the accuracy under non-IID data structure of federated learning, including extreme non-IID scenarios, combines the robustness of server based federated learning architectures with the low computing and communication cost of cyclic schemes.

The above objects are achieved by providing a computer-implemented method for efficient machine learning, the method being carried out by a server computing device and a plurality of client computing devices connected to said server computing device, wherein each of the client computing devices locally stores a local dataset, the method comprising:
a) generating, by the server computing device, a set of initial model parameters;
b) generating, by the server computing device, a set of partitioning parameters including at least the parameters Number of partitions and Minimum number of data points in the partitions;
c) communicating, by the server computing device, the set of initial model parameters and the partitioning parameters to each client computing device;
d) obtaining, by each client computing device, global values corresponding to the set of initial parameters from the server computing device;
e) selecting, by the server computing device, a client computing device based on a global sequence of all client computing devices;
f) communicating, by the server computing device, machine learning-based model parameters to the selected client computing device;
g) obtaining, by the selected client computing device, global values corresponding to the machine learning-based model parameters;
h) incrementally training, by the selected client computing device, the machine-learned model based at least in part on a partition of the local dataset to obtain updated machine learning-based model parameters, said partition being selected from the local dataset according to a predefined scheme;
i) communicating, by the selected client computing device, the updated machine learning-based model parameters to the server computing device;
j) repeating steps d)-i) until all predefined conditions are satisfied.

Various preferred embodiments of the method are defined by the dependent claims.

The above objects are also achieved by providing a server computing device and a client computing device configured to perform the respective steps of the method.

### BRIEF DESCRIPTION OF THE DRAWINGS

The invention will now be described in more details with reference to the accompanying drawings. In the drawings:

FIG. 1 is a schematic view illustrating the concept of local learning according to the prior art.

FIG. 2 is a schematic view illustrating the concept of centralized learning according to the prior art.

FIG. 3 is a schematic view illustrating the concept of federated learning according to the prior art.

FIG. 4 is a schematic view illustrating the concept of the improved federated learning according to the present invention.

FIG. 5 is a flow diagram illustrating the main steps of an example system for improved federated learning according to the present invention.

FIG. 6 is a flow diagram illustrating the main steps of the method of prior art collaborative cyclic learning (CIIL).

FIG. 7 is a flow diagram illustrating the main steps of the method according to the present invention, executed by a client computing device.

FIG. 8 illustrates the accuracy of various trained models as a function of the training rounds.

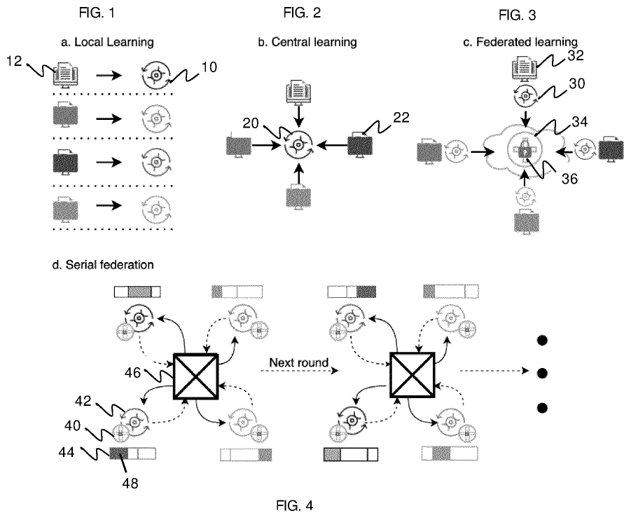

### DETAILED DESCRIPTION

### Example System

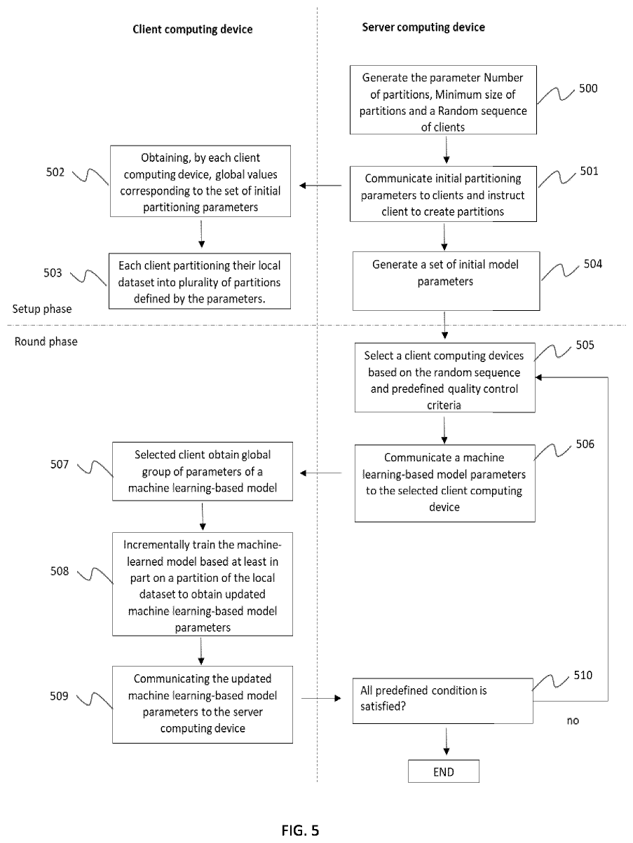

The concept of the improved federated learning according to the present invention is schematically illustrated in FIG. 4. For the sake of clarity, the improved federated learning of the present invention will be referred to as “serial federation” hereinafter.

In the serial federation learning method according to the invention, there is a single global machine-learning model 40 that is subsequently trained by a plurality of local client computing devices 42 using samples from datasets 44 locally stored in the client computing devices 42 or in separate databases (not shown) locally or remotely accessible by the client computing devices 42.

The global learning model 40 is forwarded by a central server computing device 46 to the client computing devices 42 in a cyclic manner according to a predefined global sequence of all client computing devices. The server computing device 46 functions only as an arbitrating entity that is responsible for receiving the locally updated global model 40 from a client computing device 42 and forwarding the model 40 to the next client computing device 42 based on the actual arbitration rules. There is no aggregation phase in this serial federation, as each training result is the intermediate state of the final global model 40.

In the initialization phase, the local datasets 44 are divided into n partitions 48, where the value of n is initially defined by the server computing device 46 as a global parameter common for each client computing device 42.

The global learning model 40 is dynamically trained by the client computing devices 42 using the local data partitions 48 in an order specified by the arbitrating server computing device 46. In this case, local data cannot be inferred and traced since no local parameters are transferred from the client computing devices 42.

In an example system, security behavioural settings and the communication channel settings can be defined. Normally, the server computing device 46 is honest-but-curious. In this case, the semi-honest server will follow the instructions of protocol, but attempts to infer private information using received data. Most of the researches in federated learning have adopted the semi-honest scheme, for the reason that it is in interest for all parties to follow the protocol honestly. Secondly, in cryptography, it is a standard approach to first build a security protocol against a semi-honest adversary, which can then be strengthened by zero-knowledge proofs to defend against malicious adversaries.

The communication channels between the server computing device 46 and the client computing devices 42 should be secure. For each client-server connection a secure, internal VPN can be established, which also serves to verify the identity of the clients. Meanwhile, the whole communication process is through secure HTTPS protocol.

In the method of serial federation according to the invention, the central server computing device enhances robustness. Since the server computing device is a single point of failure (SPF) in a federated system, it is advised to run multiple instances of the server computing device running in parallel. This also ensures high availability, reducing the possibility of downtime, thus in case of the failure of one instance of the server computing device, other instances thereof can still process requests. A further benefit of having multiple instances of the server computing device is that more requests can be processed at the same time for providing proper response time.

### Example Methods

The method of serial federation according to the present invention will be described below in detail with reference to FIG. 5 illustrating the main steps of the method in a flow diagram.

In serial federation, communication is orchestrated by a server computing device. A federated learning system is robust if it can maintain its performance, reliability, and security in the face of various challenges, such as noise, communication issues, adversarial attacks, and other unexpected events. A central server computing device can play a significant role in making a system more robust in the following ways:
1. Monitoring and quality assurance: The central server can monitor the performance of the global model, identify potential issues, and take corrective actions as needed. This may include detecting and handling poor-quality updates, malicious participants, or even triggering model retraining when necessary.
2. Data validation and pre-processing: The central server can perform data validation and pre-processing tasks, ensuring that the data used for model updates is accurate, clean, and consistent, which helps in maintaining the quality of the global model.
3. Adaptive learning: The central server can adapt the learning process based on the observed performance of the global model and the participating devices. This can involve adjusting learning rates, update frequencies, or even changing the model architecture to better suit the problem at hand.
4. Security and privacy enforcement: The central server can implement various security and privacy measures, such as secure aggregation and differential privacy, to protect the sensitive information of the participating devices and maintain the overall trustworthiness of the system.
5. Resource allocation and scheduling: The central server can efficiently allocate and schedule resources across the participating devices, ensuring that the system remains balanced and can handle fluctuations in device availability or communication constraints.

By managing these aspects, a central server can significantly contribute to the robustness of a federated learning system or any distributed computing system.

In a preferred embodiment of the method of the invention, the server computing device may change the state information of the model. For example, the server can act as a regularizer in the learning procedure and can skip suspicious model updates. In this embodiment, the server computing device is responsible not only for routing the updated model from one client computing device to another one, but also for regulating the learning process.

In the first step 500, the server computing device defines the following parameters: Number of partitions (n), Minimum size of partitions (sₘᵢₙ) and Random sequence of clients.

The parameter Number of partitions defines the number n of partitions into which the local datasets of the client computing devices should be divided.

The parameter Minimum size of partitions is the smallest number of data points in a partition, to make each training process more balanced in the data size. The definition of a minimum size sₘᵢₙ for the data partitions implies that all the datasets should have a size that is equal to or larger than the minimum size sₘᵢₙ multiplied by the number n of data partitions. The use of a minimum size of the data partitions supports the efficiency and accuracy of model training. The impact of data partitioning on performance is significant because it amplifies the effects of randomizing client update order. In non-IID situations, setting a high number n of partitions ensures that during each training round, the model is updated using a diverse dataset in which every pattern is represented. This leads to faster convergence of the models and thus to the reduction of computational costs.

Random sequence of clients is a vector of indices that determines the client update order. It is preferred that the server computing device defines a global sequence of the clients based on a random or pseudorandom selection of the clients, which guarantees that the client computing devices will never have information on the previous client computing device within the sequence of training. The effects of randomization of the update order of the client computing devices are similar to the randomization of datapoints before model training in the central learning scheme. Therefore, randomization of the client devices results in:
1. Avoiding Order Effects: Randomizing the order of clients helps to avoid order effects that can occur when the client data is processed in a specific order. If the clients' order is not randomized, the model may learn to be biased towards certain patterns or trends in the partitions that are related to the order in which it was presented. (This problem is more prevalent in Non-IID situations.)
2. Avoiding Overfitting: Randomization can also help to avoid overfitting, which occurs when a model becomes too closely tailored to the training data and is unable to generalize well to new data. By randomizing the order of clients, the model is forced to learn a more generalized representation of the data.
3. Enhancing Performance: Randomization can also improve the performance of the model by ensuring that it is exposed to a more diverse range of data during training. This can help the model learn to recognize and respond to patterns that it may not have encountered if the clients were not randomized.
4. Improved convergence speed: Randomization can help the model converge more quickly by ensuring that it encounters a diverse set of samples during each epoch. This exposure helps the model learn the underlying patterns in the data more effectively, preventing it from getting stuck in local optima or overfitting to specific sequences of samples.

In the step 501, the server computing device communicates the initial partitioning parameters to each client computing device through secure communication channels and instructs the client computing devices to create partitions.

Preferably, the minimum partition size sₘᵢₙ and the number n are sent by broadcasting from the server computing device to all client computing devices at the initialization of the training process.

In the step 502 each client computing device obtains the global values corresponding to the set of initial partitioning parameters.

In the step 503, each client computing device divides its local dataset into the particular number n of data partitions, each partition containing at least sₘᵢₙ number of data points, defined by the partitioning parameters.

Both the step 503 of data partitioning and the step 500 of randomizing the client update order have a significant effect on federated leaning convergence speed. The main factor of the computational cost in federated learning is the convergence speed that is directly proportional to the computational resource usage.

In the step 504, the server computing device generates initial untrained machine learning-based model parameters. These parameters serve as an initial model for training on the selected partition of the client computing devices.

In step 505, the server computing device selects a client computing device based on the parameter Random sequence of clients determined in step 500 and predefined quality control criteria.

Quality control criteria may be defined by the server computing device, which can also be the data owner, and it can use its own data to track the training progress and intervene when there is a significant decrease in accuracy compared to a previous model, based on a predefined threshold. In such cases, the server computing device can send the earlier, better-performing model to the next client computing device for further training.

In step 506, the server computing device communicate the machine learning-based model parameters to the selected client computing device. The first selected client computing device always receives untrained, initial model parameters.

In step 507, the selected client computing device obtains a global set of parameters of a machine learning-based model.

In step 508, the selected client computing device incrementally trains the machine-learned model based, at least in part, on a partition of the local dataset to obtain updated machine learning-based model parameters.

The incremental training step 508 solves the problem of continuous private update on the federated learning model in the presence of continuously added data. With the data partitioning in the serial federation structure, when new data is added, only another round of model training is necessary, which reduces the complexity of the method.

In step 508, the partition is selected from the local dataset according to a predefined scheme, preferably choosing the next partition randomly from the set of local partitions without replacement and when there is no more partition restarting the process.

For training the model, the selected client computing device uses a local machine-learned model. The type of the local learning model used strictly depends on the application considered. For example, in a model with a correct model-updating scheme, the model may be a convolutional neural network (CNN), a feedforward neural network (FNN), a Long Short Term Memory networks (LSTM), K-means, or a naïve Bayes classifier. Due to the incremental training step, in general, any online learning algorithm can be used for training the model.

In an example method, a time setting for each client training can be also fixed and supervised by the server computing device. Depending on the size of the data partition, when datasets are smaller, a shorter waiting time can be set (e.g., 1 min), when datasets are larger, longer waiting time can be set (e.g. 5 min). In this case, even if one or more of the client computing devices drop the system, it will not lead to a failed training.

The specific steps of the training algorithm performed by the server computing device are shown in Example Algorithm 1.

Algorithm 1: Serial Federation in the Server Side

```
Input: Untrained model, number of partitions n, minimal partition size sₘᵢₙ
Output: Final model [symbol]
create an initial model [symbol]   for updating ;
for i ← 1 to n_{c} do
  | Instruct Cᵢ to create D_{i,1}, D_{i,2}, . . . , D_{i,n} disjoint partitions ; //
  |_ (Dᵢ = ∪ⱼD_{i,j}) ∧ (|D_{i,j}| ≥ sₘᵢₙ∀j ∈ {1, 2, . . . , n})
for i ← 1 to nₛ do
  | Select πᵢ ∈ [symbol]   ₙ_{_{c}};
  | for j ← 1 to n_{c} do
  | | [symbol]   send s( [symbol]   ) = Qₛ to client C_{π}_{ᵢ}₍ⱼ₎ to update;
  | | [symbol]   ← fₘ(s⁻¹(Qₛ), D_{i,π}_{ᵢ}₍ⱼ₎) ; // C_{π}_{ᵢ}₍ⱼ₎ call the update function
  | | fₘ
  | | C_{π}_{ᵢ}₍ⱼ₎ send s( [symbol]   ) back to [symbol]    ;
  |_ |_ [symbol]   performs (regularization/criterion based update) on [symbol]
return [symbol]
```

The specific steps of the training algorithm performed by the client computing devices are shown in Example Algorithm 2.

Algorithm 2: Serial Federation in the Learning Client Side

| | Input: ML algorithm fₘ, number of databases partitions n, n ≥ 2, the |
|---|---|
| | minimum size of partitions sₘᵢₙ |
| | Output: Updated model |
| 1 | D = Σ₁ⁿI Dᵢ ; // Divide databases into partitions based on server's |
| | instruction |
| 2 | [symbol] queries with Qₛ |
| 3 | Cᵢ computes updated model [symbol] = fₘ(Qₛ) under data partition Dᵢ |
| 4 | return [symbol] |

In step 509, the client computing device communicates the updated machine learning-based model parameters to the server computing device through a secure communication channel.

In step 510, the server computing device receives the updated machine learning-based model from the selected client computing device and repeats the iteration until a predefined condition is satisfied.

The predefined condition may be satisfied for example when the model reaches a state where further training does not significantly improve its accuracy (e.g., the change between the models of the previous and current round of training is smaller than a predefined percent or difference). In another example, the predefined condition may be satisfied, for example, when the number of training rounds has met or exceeded a predefined threshold number (e.g., defined by an administrator of the server computing device).

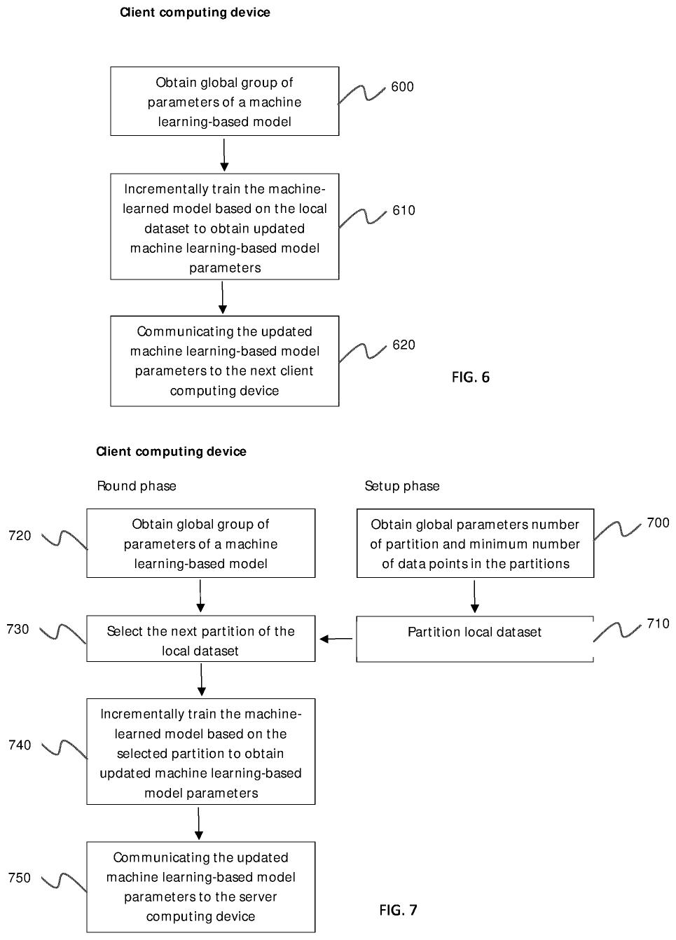

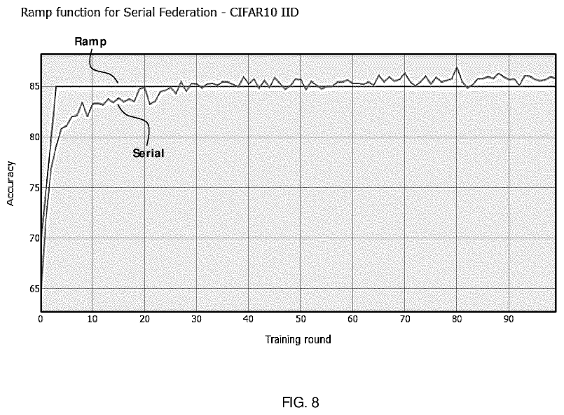

The main differences between an example method of cyclical learning (i.e. CIIL scheme) and an example embodiment of the serial federation method according to the present invention are described below in detail with reference to the flow diagrams shown in FIG. 6 and FIG. 7, respectively, illustrating the main steps of the methods performed by a client computing device.

Both methods involve a step of obtaining group of parameters of a machine learning-based model, i.e. steps 600 and 720, respectively, and a step of incrementally training the model with local data, i.e. steps 610 and 740, respectively. The method of CIIL focuses on training the model with the entire local dataset in step 610 and then passing the updated parameters to the next client in step 620, while the method of serial federation divides the local dataset into a plurality of partitions in step 710 and trains the learning model using one partition at a time in step 740.

In the method of CIIL, the updated model parameters are communicated to the next client computing device in step 620, whereas in the method of serial federation, they are sent to the server computing device in step 750.

The method of serial federation involves an additional setup phase to determine the number n of partitions and the minimum number sₘᵢₙ of data points per partition in step 700, unlike the method of CIIL, which does not require this step.

The method of serial federation according to the present invention has the following advantages with respect to the prior art machine learning processes:
It accurately works in extreme non-IID scenarios, creating a new functionality for federated scenarios.
It significantly reduces the computation cost on the client side due data partitioning and the random sequence of the clients.
It can adopt to any kind of online machine learning methods.
It addresses the challenge of continuous updating the machine learning model with new data.
Server provides robustness to federated training process.

### Example Experiments

To assess the method's capabilities, tests for multiple training settings were performed on the CIFAR10 dataset with varying level of non-IIDness on a standard DenseNet neural network that can achieve up to 90% accuracy when trained centrally (Huang et al. Densely Connected Convolutional Networks. https://arxiv.org/abs/1608.06993). To quantify computational costs in the experiments, convergence was measured. The main goal of the experiments was to show that serial federation performs just as well as other protocols in general settings, and when the datasets are non-IID, then it has a significantly better performance, providing both increased accuracy and decreased convergence time of training on clients, leading to significant client-side computational cost reduction.

It was a further aim to show that in non-IID edge cases, when each client computing device possesses samples with only one type of label, the method of serial federation according to the invention still converges and provides accurate models, while other algorithms would never or extremely slowly converge. The experiments also aimed to provide quantitative proof of the effect of client sequence randomization and data partitioning on convergence, i.e., computational efficiency.

### Experiment Methods

In the experiments, the cyclical institutional learning (CIIL) scheme without client sequence randomization (Chang et al., “Distributed deep learning networks among institutions for medical imaging”, Journal of the American Medical Informatics Association, Volume 25, Issue 8, August 2018, pp. 945-954), the cyclical institutional learning scheme (CIIL) with client sequence randomization, an adaptive FedAvg protocol called FedYogi and the method of Serial Federation according to the present invention were compared and analyzed. For each protocol, the same model with the same optimizer and loss criterion was used. The neural network comprised DenseNet (Huang et al. Densely Connected Convolutional Networks. https://arxiv.org/abs/1608.06993) with stochastic gradient descent optimizer with learning rate 0.01, momentum 0.9, weight decay 5e-4. For each test, 100 epochs were performed in total, which number was defined as the product of the number of local epochs and the number of training rounds. The tests were performed with 6 client computing devices in order to imitate a real-world scenario of cross-silo federated learning.

To represent the capabilities of the most widely used federated learning method (FedAvg), an advanced method was selected that aimed to fix its known issues of unfavorable convergence behavior. Based on the study of Reddi et al. “Adaptive Federated Optimization” (https://arxiv.org/abs/2003.00295v5), out of the 3 presented adaptive federated optimizations (FedYogi, FedAdam, FedAdagrad), the scheme FedYogi was the fastest in convergence and had the highest accuracy on cifar10, so this scheme was used as a baseline. For the experiments, the Flower 1.4.0 federated learning framework adaptive federated optimization implementation was used. The following FedYogi specific parameters were used for all test: server-side learning rate (eta): 1e-1, Beta2 momentum: 0.9, degree of adaptability (tau): 1e-9.

Example implementation of Serial Federation of server and client computing device functions were based on Example Algorithm 1 and 2. The random sequence of the client computing devices was sampled uniformly from the permutations of {1, 2, 3, 4, 5, 6} for each global training rounds (the global sequence can be generated at once by concatenating the permutations together). After 100 global training rounds (predefined condition), the algorithm exists. The following further Serial Federation specific parameters were used for all tests: the number of partitions was chosen to n=2, the minimum number of data points in a partition was sₘᵢₙ=100, the client update order was sampled uniformly from the permutations of {1, 2, 3, 4, 5, 6}.

The following common parameters were used for all three methods: client-side learning rate(eta1) 1e-2. The local ML batch size was fixed to 128 for all tests, local epochs were set to 1 to maximize accuracy with the tradeoff being increased total network usage. All client computing devices participated in every training round.

Convergence is achieved when the global model reaches a state where further training does not significantly improve its accuracy. The speed of the convergence is inversely proportional to the minimum amount of training round needed to achieve convergence. Not counting the infrastructure, the federated learning methods can have dramatic effect on the convergence speed, hence the computational cost.

When the trainings achieved convergence, the number of training-rounds as a function of accuracy can be approximated with a simple ramp function defined as the following:

$$f ( x , T , A , {A}_{0} ) = \{ \begin{matrix}\frac{( A - {A}_{0} ) x}{T} + {A}_{0} & x < T \\ A & x \geq T\end{matrix}$$

In this context, the fitted parameter T is directly proportional to the minimum number of training rounds required to achieve convergence. The parameter A is proportional to the accuracy of the model after convergence, whereas A₀ represents the initial accuracy and is not fitted. The fitting procedure can be performed using analytical solutions through the least squares method, Monte Carlo maximum likelihood (ML) or Bayesian methods.

The total computational cost is related to the number of rounds (T) and the number of computers (n_{c}) involved in each learning step. The Total Computational Factor (TF) is a straightforward whole number that represents the number of model updates required for convergence.

TF=n_{c}T

### Experiment Data

The CIFAR10 dataset was randomly split between the client computing devices and depending on the test, a label shift was performed during the split. In the case of non-IID tests, the datasets were created in two ways. In the first case two groups of client computing devices are defined such that half of the client computing devices receive more data with labels from 0 to 4 and the other group receives data with labels from 5 to 9. The second case was the most extreme case possible where 10 client computing devices are used, where each client computing device possesses only one label. The numbers are the numeric representation of the labels for the images. The following non-IID datasets were tested for less extreme cases: 30% to 70%, 10% to 90% and 1% to 99% ratios between the labels.

### Experiment Results

The values of accuracy and the total computational factor of the various schemes for different label ratios resulted from the tests are summarized in Table 1 below.

| | IID | 30/70 | 10/90 | 1/99 |
|---|---|---|---|---|
| MAXIMUM | | | | |
| ACCURACY | | | | |
| Fed Yogi | 0.83 | 0.77 | 0.78 | 0.76 |
| CIIL | 0.85 | 0.76 | 0.75 | 0.61 |
| CIIL + random | 0.85 | 0.85 | 0.78 | 0.61 |
| sequence | | | | |
| Serial Federation | 0.85 | 0.85 | 0.85 | 0.80 |
| (CIIL + random | | | | |
| sequence + | | | | |
| partitioning) | | | | |
| TOTAL COMPUTATIONAL | | | | |
| FACTOR | | | | |
| Fed Yogi | 18 | 30 | 54 | 72 |
| CIIL | 4 | 9 | 9 | 42 |
| CIIL + random | 4 | 4 | 8 | 46 |
| sequence | | | | |
| Serial Federation | 4 | 4 | 5 | 13 |
| (CIIL + random | | | | |
| sequence + | | | | |
| partitioning) | | | | |

The accuracy of the trained models was assessed after each training round and both the accuracy and the computational round were determined. The numeric representation for this was made with fitting a ramp function for the accuracy vs. training rounds as shown in FIG. 8.

The experiment results show that in the case of IID data, the method of serial federation according to the invention has the same performance as the cyclical institutional learning with or without randomization, however as the extent of non-IID-ness increases, the method of Serial Federation clearly starts to outperform the other protocols both in accuracy and convergence speed.

Each additional feature (i.e., client randomization, partitioning) added to the scheme Cyclical Institutional Learning has been demonstrated to result in significant technological advancements over the original method, including faster convergence (i.e., computational cost reduction) and improved accuracy. The introduction of update order randomization alone contributed to quicker convergence and higher accuracy in both IID and moderately non-IID scenarios. Partitioning client data led to additional improvements in performance and reduced computational costs, even in non-IID cases. Remarkably, the method of Serial Federation according to the invention excelled even in extremely non-IID situations.

Experimental results show that the method of serial federation according to the invention has better performance on non-IID dataset comparing to the state-of-the-art adaptive FedAvg algorithm. It is more robust comparing to other cyclical federation schemes. Experiments further show that serial federation according to the invention can reach higher accuracy with less total computational factor. Serial federation of the invention provides bandwidth usage similar to CIIL but uses less computation resources because of the faster convergence.

### ADDITIONAL DISCLOSURE

The technology discussed herein makes reference to server and client computing devices, databases, software applications, and other computer-based systems, as well as actions taken, and information sent to and from such systems. Information exchanged within computer-based systems showcases their inherent flexibility, which allows for a multitude of configurations, task divisions, and functional combinations between components. Processes can be executed using either a single or multiple devices working collaboratively. Databases and applications can be implemented on one system or distributed across multiple systems. The current subject matter has been discussed in depth with respect to various specific example embodiments for explanatory purposes and not as limitations. Those with expertise in the field can easily create alterations, variations, and equivalents to these embodiments upon understanding the subject matter. Consequently, the disclosure does not exclude any modifications, variations, or additions that would be evident to a person with ordinary skill in the art. For example, features depicted or explained as part of one embodiment can be employed with another embodiment to create a new embodiment. The intention is for the current disclosure to cover such alterations, variations, and equivalents.

1. A client computing device, including:
a processing unit; and
a non-volatile, computer-readable storage medium containing local dataset and instructions that, upon execution by the aforementioned processing unit, direct the client computing device to carry out a series of functions, said functions consisting of:
a) obtaining global values corresponding to a group of parameters associated with a machine learning-based model;
b) incrementally training the machine-learned model based, at least in part, on a partition of the local dataset to obtain updated machine learning-based model parameters; and
c) communicating the updated machine learning-based model parameters to the server computing device.

2. The client computing device of claim 1, wherein generating the partition of the local dataset comprises:
a) obtaining global values corresponding to a set of parameters associated with the Number of partitions to be generated and the Minimum number of data points in the partitions; and
b) dividing the local datasets into a plurality (n) of partitions defined by the parameter Number of partitions, wherein one partition has at least a number sₘᵢₙ of data points, wherein the value of sₘᵢₙ is defined by the parameter Minimum number of data points in the partitions.

3. A server computing device, including:
a processing unit; and
non-volatile, computer-readable storage medium containing instructions that, upon execution by the aforementioned processing unit, direct the server computing device to carry out a series of functions, said functions consisting of:
a) selecting client computing devices based on a global sequence of all client computing devices and predefined quality control criteria;
b) communicating machine learning-based model parameters to a selected client computing device; and
c) receiving the updated machine learning-based model from the selected client computing device.

4. The server computing device of claim 3, wherein the global sequence of the client computing devices generated by a computational method comprising a random or pseudorandom mathematical or statistical algorithm.

5. The server computing device of claim 3, further configured to:
a) generate a set of initial parameters associated with a machine learning-based model;
b) generate a parameter Number of partitions;
c) generate a parameter Minimum number of data points in the partitions; and
d) generate a parameter Random sequence of client computing devices.

6. A computer-implemented method for computationally efficient machine learning, comprising:
a) generating, by a server computing device, a set of initial model parameters;
b) generating, by the server computing device, a set of partitioning parameters including at least the parameters Number of partitions and Minimum number of data points in the partitions;
c) communicating, by the server computing device, the set of initial model parameters and the partitioning parameters to each of a plurality of client computing devices;
d) obtaining, by each client computing device, global values corresponding to the set of initial parameters from the server computing device;
e) selecting, by the server computing device, a client computing device based on a global sequence of all client computing devices;
f) communicating, by the server computing device, machine learning-based model parameters to the selected client computing device;
g) obtaining, by the selected client computing device, global values corresponding to the machine learning-based model parameters;
h) incrementally training, by the selected client computing device, the machine-learned model based, at least in part, on a partition of the local dataset to obtain updated machine learning-based model parameters, said partition being selected from the local dataset according to a predefined scheme;
i) communicating, by the selected client computing device, the updated machine learning-based model parameters to the server computing device;
j) repeating steps d)-i) until all predefined conditions are satisfied.
